(19) United States
(12) Patent Application Publication
(10) Pub. No.: US 2009/0172469 A1
(43) Pub. Date: Jul. 2, 2009

(54) METHOD, APPARATUS, LOGIC DEVICE AND STORAGE SYSTEM FOR POWER-FAIL PROTECTION

(75) Inventor: Ji XIAO, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/341,446

(22) Filed: Dec. 22, 2008

(30) Foreign Application Priority Data
Dec. 27, 2007 (CN) 200710307035.X

(51) Int. Cl. G06F 11/16; G06F 13/36

(52) U.S. Cl. 714/14; 710/315; 714/E11.054

(57) ABSTRACT

A method, apparatus, logic device, and storage system for power-fail protection are disclosed. The method includes: when a system power supply fails, supplying, by a battery, power to a south bridge chip (SBC), a non-volatile flash storage medium, an interface conversion circuit (ICC) between the SBC and the non-volatile flash storage medium and a memory; and transmitting unsaved data in the memory to the corresponding non-volatile flash storage medium via the ICC, by using an unused bus interface of the SBC. The ICC converts a bus interface of the SBC into a corresponding bus interface of the non-volatile flash storage medium. The embodiments of the invention can effectively solve problems of data loss in case of system power failure and short retention time, and realize protection operation in case of system power failure, convenient upgrading memory capacity, and saving system space, without adding cost and total capacity of battery.

### CROSS-REFERENCE TO RELATED APPLICATIONS

This application claims priority to Chinese Patent Application No. 200710307035.X, filed Dec. 27, 2007, entitled “Method, Apparatus, Logic Device and Storage System for Power-Fail Protection,” the contents of which are hereby incorporated by reference in its entirety.

### TECHNICAL FIELD OF THE INVENTION

The present invention relates to the field of data communication technology, and, more particularly, to a method, apparatus, logic device, and storage system for power-fail protection, which can prevent data loss.

### BACKGROUND OF THE INVENTION

Special storage devices have very high requirement on data safety. In the process of writing data into hard disks, the data is firstly written into the memory, and then written from the memory into the hard disk. Because the memory is a volatile storage medium, all data in the memory that has not yet been written into the hard disk will get lost, in case of sudden power failure during the process of writing data into the hard disks through the memory. Therefore, in case of sudden power failure, storage devices need to save all the data in the memory that has not yet been written into the hard disk, so as to prevent data loss. This is called power-fail protection of storage devices.

Currently there exist two methods for power-fail protection of storage devices:

I. Protecting the Memory by Battery

As shown in FIG. 1, under normal conditions, the whole storage device is powered by a system power supply that ensures that the storage device works normally. In case of accidental failure of the system power supply, the memory gets power from a battery and preserves the data therein from getting lost; when the system power supply is recovered to work normally again, it supplies power to the whole storage device; and the data saved in the memory is written into a hard disk.

II. Protecting the Memory by Using Hard Disk Safe Box

As shown in FIG. 2, an essential module and several designated hard disks (referred to as hard disk safe box or designated hard disk) are provided in the storage device. The function of the essential module is to ensure that data in the memory can be correctly written into the designated hard disk in case of power failure. The essential module usually includes the essential circuits such as CPU, a memory, a south bridge, etc. Under normal conditions, the whole storage device is powered by a system power supply for ensuring that the storage device works normally; in case of accidental failure of the system power supply, the essential module and the designated hard disk get power from the battery, and the data in the memory that needs to be saved is written into the designated hard disk; when the system power is recovered to work normally, it supplies power to the whole storage device, the data saved in designated hard disk is read out and written into the memory, and then subsequent tasks are carried out.

In the process of implementing the invention, it is found that the prior art has at least the following problems:

In the first method, although the battery only supplies power to the memory, it has limited capacity, thus, the data in the memory can only be saved for a limited period of time, rather than permanently. If the system power supply is not recovered during this period of time, the data in the memory will get lost anyway.

In the second method, although the data in the memory is stored in a hard disk and thus saved permanently, the essential module and the designated hard disk need to be supplied with power, thus, the power consumption is high, and the requirement on the capacity and high-current discharge of the battery is also high.

The memory capacity is difficult to upgrade with either one of the existing methods of power-fail protection.

With continuous development of CPU technology, the system has ever-increasing demand on the memory capacity. Increased memory capacity leads to its increased power consumption, as well as multiplied amount of data that needs to be saved in case of power failure; therefore, the capacity of battery also needs to be multiplied in order to meet the demand. However, the capacity of a unit of battery develops at a rate much lower than that of the memory capacity. Under the condition of increased power consumption of the memory and constant capacity of the battery, the duration of data being retained in the memory becomes shorter, thus, increasing the risk of data loss. If the total battery capacity is expected to increase, it can only be realized by increasing the quantity of batteries, so that not only the cost is raised, but also the system architecture is undermined with an increased number of batteries, which occupy too much space of the storage device.

### SUMMARY OF THE INVENTION

According to one aspect of the present invention, a method for power-fail protection is provided for solving the problem of data loss in the prior art in case of system power failure, problems of short retention time in the existing power-fail protection, and difficulty in upgrading the memory capacity, etc., and for realizing protection in case of system power failure, without adding cost or the total capacity of battery.

According to another aspect of the invention, an apparatus for power-fail protection is provided for solving the problem of data loss in existing storage devices in case of system power failure and problems of short retention time in the existing storage devices at the time of power-fail protection, difficulty in upgrading the memory capacity, etc., and for realizing protection in case of system power failure without adding cost or the total capacity of battery.

According to yet another aspect of the invention, a logic device is provided for solving the problems of short retention time of battery, and difficulty in upgrading the memory capacity, etc. in power-fail protection in the prior art, and for realizing protection in case of system power failure without adding cost or the total capacity of battery.

According to still another aspect of the invention, a storage system is provided for solving the problem of data loss in the existing storage system in case of system power failure and problems of short retention time in the existing method for power-fail protection, and difficulty in upgrading the memory capacity, etc., and for realizing protection in case of system power failure, without adding cost or the total capacity of battery.

In order to realize one aspect of the invention, the method for power-fail protection according to some embodiments of the invention includes: when a system power supply fails, supplying, by a battery, power to a south bridge chip (SBC), a non-volatile flash storage medium, an interface conversion circuit (ICC) between the south bridge chip and the non-volatile flash storage medium, and a memory; and transmitting unsaved data in the memory to the corresponding non-volatile flash storage medium via the ICC, by use of an unused bus interface of the SBC; and the ICC converts a bus interface of the SBC into a corresponding bus interface of the non-volatile flash storage medium.

In order to realize another aspect of the invention, the apparatus for power-fail protection according to some embodiments of the invention includes: a south bridge chip (SBC), configured to control interfaces of a storage system; a non-volatile flash storage medium, configured to storing data; and an Interface conversion circuit (ICC) connected to the SBC and the non-volatile flash storage medium, configured to convert a bus interface of the SBC into a corresponding bus interface of the non-volatile flash storage medium; transmit data not stored in a memory to the corresponding non-volatile flash storage medium via a bus interface connected to the SBC, when a system power supply fails.

In order to realize yet another aspect of the invention, the logic device according to some embodiments of the invention includes: one or more conversion units, configured to convert a bus interface of a South Bridge Chip (SBC) into a corresponding bus interface of one or more non-volatile storage mediums. One end of each conversion unit is connected to the bus interface of the SBC, and other end of each conversion unit is connected to the corresponding bus interface of the non-volatile storage mediums.

In order to realize still another of the invention, the storage system of some embodiments of the invention includes: a system power supply, configured to supply the storage system with power under normal conditions of the system; a South Bridge Chip (SBC), configured to control interfaces of the storage system; a non-volatile flash storage medium, configured to storing data; an Interface Conversion Circuit connected to the SBC and the non-volatile flash storage medium, configured to convert a bus interface of the SBC into a bus interface of the non-volatile flash storage medium; a system memory connected to a central processing unit (CPU), configured to directly communicate with the CPU and store data and program which are used currently; a battery connected to the SBC, the non-volatile flash storage medium, the ICC, the system memory and the CPU, configured to supply power to these connected components in case of system power failure; and the CPU connected to the SBC and the system memory, configured to transmit data not stored in the system memory to the corresponding non-volatile flash storage medium via the ICC, by use of an unused bus interface of the SBC, in case of system power failure.

The above embodiments use the non-volatile flash storage medium as the storage medium for power-fail protection, and save the unsaved data in the memory into the non-volatile flash storage medium via the ICC between them using the unused bus interface(s) of the SBC. The non-volatile flash storage medium includes Compact Flash Card (CF), Multimediums Card (MMC), Secure Digital Card (SD), Extreme Digital Card (XD), or flash chip, etc. Compared with the methods for power-fail protection in the prior art, the above embodiments have the following advantages:

Using the non-volatile flash storage medium as the storage medium for power-fail protection storage can lower the requirement on battery capacity, as the non-volatile flash card and the flash chip have lower power consumption; additionally, the capacity of the non-volatile flash card and the flash chip develops quickly, so the requirements on capacity of data saving and the memory can be raised by increasing the number of non-volatile memory cards or chips, thus, making it easy for upgrading.

Because of the high requirement of reliability on storage devices, every module has 1 +1 redundancy, and the space of system is very tight. Having the features of being small and light, the non-volatile flash storage medium can be placed on a single board directly, so that the space of the system is saved, and the architecture of the system is little affected even with increased number of storage cards.

Using the non-volatile flash storage medium to save the data in the memory in case of power failure makes it possible to preserve data permanently until the system power is recovered to work normally.

By using the unused system bus(es) of SBC and non-volatile flash storage, the protection in case of system power failure can be realized under the condition of adding neither cost nor the total capacity of battery.

Power consumption can be minimized by determining the capacity and the number of devices of the non-volatile flash storage medium, based on the size of the memory that the system needs to protect, and stopping power supply to other peripheral chips during power-fail protection.

The technical solutions of the embodiments of the present invention are further elaborated in the following with reference to drawings.

### BRIEF DESCRIPTION OF THE DRAWINGS

FIG. 1 is a schematic structure diagram for power-fail protection;

FIG. 2 is another schematic structure diagram for power-fail protection;

FIG. 3 is a flow chart of one embodiment of the method for power-fail protection according to the present invention;

FIG. 4 is a flow chart of another embodiment of the method for power-fail protection according to the present invention;

FIG. 5 is a flow chart of still another embodiment of the method for power-fail protection according to the present invention;

FIG. 6 is a schematic diagram of one embodiment of the apparatus for power-fail protection according to the present invention;

FIG. 7 is a schematic diagram of an embodiment of the ICC in the apparatus for power-fail protection according to the present invention;

FIG. 8 is a schematic diagram of one embodiment of the SBC and ICC in the apparatus for power-fail protection according to the present invention;

FIG. 9 is a schematic diagram of another embodiment of the SBC and ICC in the apparatus for power-fail protection according to the present invention;

FIG. 10 is a schematic diagram of still another embodiment of the SBC and ICC in the apparatus for power-fail protection according to the present invention;

FIG. 11 is a schematic diagram of an embodiment of the logic device according to the present invention; and

FIG. 12 is a schematic diagram of an embodiment of the storage system according to the present invention.

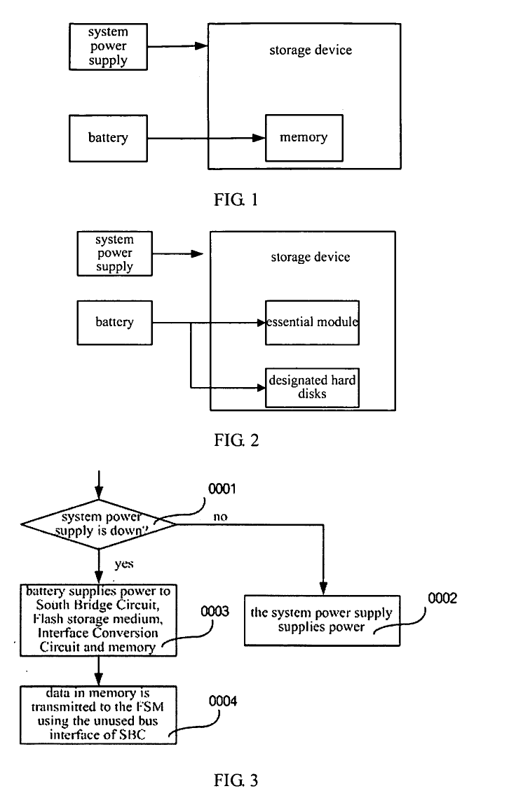

### EMBODIMENTS OF THE INVENTION

FIG. 3 shows the flow chart of one embodiment of the method for power-fail protection, according to the present invention.

As shown in FIG. 3, the method includes as follows:

Step 0001: It is determined whether the system power supply fails. If fails, the process proceeds with Step 0003; otherwise, proceeds with Step 0002;

Step 0002: The system power supply supplies power, and the process ends;

Step 0003: A battery supplies power to the South Bridge Chip (SBC), Flash storage medium (FSM), Interface Conversion Circuit (ICC), and the memory; and

Step 0004: The unsaved data in the memory is transmitted to the corresponding FSM via the ICC by using the unused bus interface(s) of the SBC.

The ICC is configured to convert the bus interface(s) of the SBC into the corresponding bus interface(s) of non-volatile flash memory. Those skilled in the art should understand that the core of a system motherboard is its chipset, which determines the specification, performance, and approximate functions of the motherboard. The chipset usually includes a SBC and a north bridge chip (NBC). The NBC mainly determines the motherboard's specification and support to hardware as well as system performance, and the SBC mainly determines the motherboard's function, and various interfaces on the motherboard, such as a serial port, a Universal Serial Bus (USB), a Peripheral Component Interconnection Bus (PCI bus) and an Integrated Drive Electronics (IDE). The IDE bus is usually connected to a hard disk, an optical disk driver, etc. Other chips on the motherboard, such as integrated sound card and integrated network adapter, are controlled by the SBC.

Because the motherboard system usually does not use all buses of the SBC, in the embodiment, the free bus interfaces are used to transmit the unsaved data in the memory. In storage medium design, non-volatile flash storage medium, such as a CF card, a MMC card, a SD card, a XD card, or a flash chip, is chosen as the medium for data storage to save the unsaved data in the memory.

Because the bus interfaces of the SBC might not be compatible with the interface of the flash storage medium, data can not be written directly into the FSM. In this case, an ICC can be added between the FSM and the SBC to covert the bus interfaces of the SBC into corresponding FSM bus interfaces of the FSM, before writing data in the FSM.

In the embodiment, the unused SBC bus interface(s) and flash storage medium are used to perform data transmission for power-fail protection. In comparison with the prior art, the embodiment has the following advantages of:

(1) Low power consumption: Non-volatile flash card and flash chip have lower power consumption, and the requirement on battery capacity can be lowered;

(2) Easy upgrading: The capacity of non-volatile flash card and flash chip develops quickly, and can meet the requirement on memory capacity; and the capacity of data storage can be raised by increasing the number of non-volatile memory cards or chips;

(3) Little effect on architecture: Non-volatile flash cards and flash chips are small, e.g. the physical dimension of CF card is 43 mm*36 mm*3.3 mm; the physical dimension of MMC card is 32 mm*24 mm* 1.4 mm; the physical dimension of SD card is 32 mm*24 mm*2.1 mm; the physical dimension t of XD card is 2 mm*25 mm*17 mm. There is limited effect on system architecture, even adding several flash storage cards;

(4) Saving system space: The reliability requirement on storage devices is strict, every module has 1+1 redundancy, and the space of system is tight; the non-volatile flash storage medium has the features of being small and light, and can be arranged on a single board directly, thus, saving system space;

(5) Permanent data retention: The non-volatile flash storage medium is used to store the data in the memory in case of power failure; and date can be preserved permanently, when the system power is not recovered;

(6) No extra cost: By using the unused system bus(es) of SBC and non-volatile flash storage, protection in case of system power failure, convenient memory capacity upgrade, and system space saving can be realized under the condition of adding neither cost nor the total capacity of battery;

(7) Minimized power consumption: By determining the capacity and number of non-volatile flash storage mediums based on the size of the memory that the system needs for protection, and stopping power supply to other peripheral chips during power-fail protection, the power consumption can be minimized.

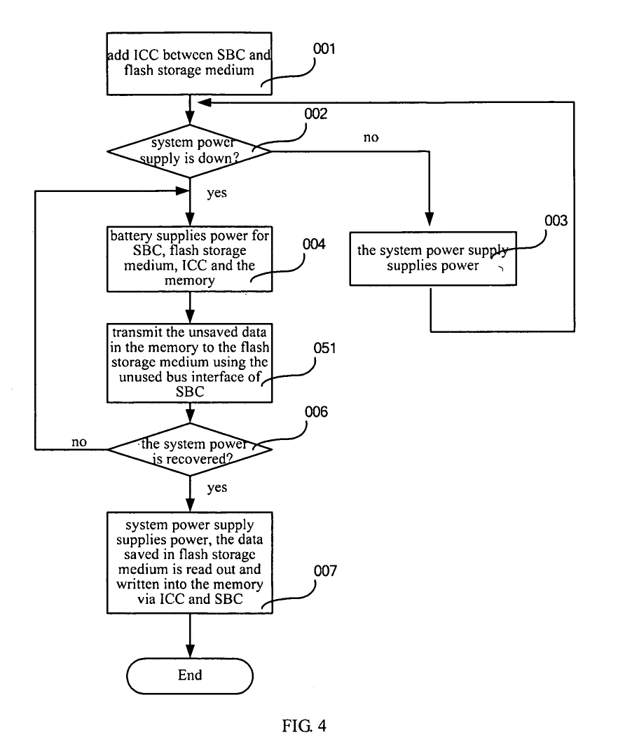

FIG. 4 shows the flow chart of another embodiment of the method for power-fail protection according to the invention. As shown in FIG. 4, the embodiment is similar to the embodiment of FIG. 3, and has all the same functions and benefits as the embodiment of FIG. 3, but with refined details.

As shown in FIG. 4, the method includes as follows:

Step 001: An ICC is added between SBC and non-volatile flash storage medium.

Step 002: It is determined whether the system power supply fails. If fails, the process proceeds with Step 004; otherwise, proceeds with Step 003.

Step 003: The system power continues to supply power, and the process returns to Step 002.

Step 004: A battery supplies power for the SBC, the storage medium, the memory, and the ICC.

Step 051: The unsaved data in the memory is transmitted to the corresponding non-volatile flash storage medium via the ICC, using the unused bus interface(s) of the SBC.

Step 006: It is determined whether the system power supply is recovered. If recovered, the process proceeds with Step 007; otherwise, returns to Step 004.

Step 007: The system power supply supplies power, reads out the data saved in the non-volatile flash storage medium and writes it into the memory via the ICC and SBC; the process proceeds with operations before the system power failure.

According to the embodiment, under normal conditions, the system power supply supplies power for the system and ensures normal operation of the system; in case of accidental system power failure, the occupied bus interface(s) of the SBC are not supplied with power so that power consumption is minimized, and the battery only supplies power for the memory, SBC, ICC, flash storage medium, etc. to transmit the data not yet written into a hard disk to the ICC via the SBC and save it in the flash storage medium after conversion; after system power is recovered, it supplies power for the entire storage device, and the data in the flash storage medium is read out, written into the memory, and then written into a corresponding hard disk.

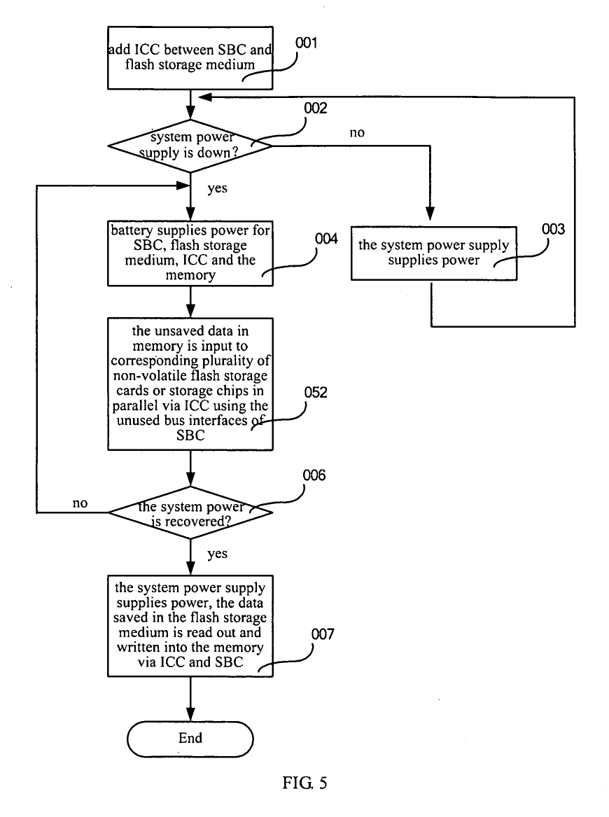

FIG. 5 shows the flow chart of yet another embodiment of the method for power-fail protection according to the invention. As shown in FIG. 5, the embodiment is similar to the embodiment of FIG. 4, but includes the following step after Step 004:

Step 052: The unsaved data in the memory is transmitted to the corresponding flash storage cards or flash chips in parallel via the ICC by using the unused bus interface(s) of the SBC.

According to the above embodiments, in case of accidental system power failure, the battery only supplies power for the memory, SBC, ICC, flash storage medium, etc. but not for hard disks or other chips, so that power consumption is minimized and the requirement on battery capacity is lowered.

General battery capacity=the minimum power consumption that enables writing memory data into flash storage medium*(total memory capacity/writing bandwidth)

As can be seen from the above equation, under the condition of constant minimum power consumption and total memory capacity, the higher the bandwidth of writing into flash storage medium, the smaller battery capacity is required; battery capacity is reduced by half when writing bandwidth doubles. Therefore, by increasing the writing bandwidth, the battery capacity can be saved by the greatest extent, and the slow development of battery can be accommodated.

Usually the transmission bandwidth of the south bridge bus is much larger than bandwidth of the flash storage medium, therefore, the bandwidth for writing data can be increased by just increasing the bandwidth of flash storage medium. According to the embodiment, in the ICC design, a bus interface of the SBC is converted into a data interface that corresponds with a plurality of storage mediums, into which the data is written in parallel, thus, realizing multiplied bandwidth. For example, the interface between the SBC and the ICC is a USB 2.0 interface, which has a bandwidth of 60 Mega Byte per second (M Bps). Assuming the bandwidth of single flash chip is 10M Bps, and then the bandwidth for writing data is only 10M Bps. If the ICC converts a USB 2.0 interface for corresponding simultaneously with three identical flash chip bus interfaces, and writes data in parallel, then the bandwidth of writing data into flash chips is increased to 3*10M Bps=30M Bps.

In the above embodiments, the transmitting the unsaved data in the memory to the corresponding non-volatile flash storage medium via the ICC by using the unused bus interface(s) of the SBC includes: transmitting the unsaved data in the memory to the corresponding non-volatile flash storage mediums in parallel via the ICC using one unused bus interface of the SBC; or transmitting the unsaved data in the memory to the corresponding non-volatile flash storage mediums in parallel via the ICC using several unused bus interfaces of the SBC, in which, one bus interface corresponds with a plurality of flash storage mediums, e.g. one USB bus of the SBC corresponds with 3 flash storage cards; one PCI bus corresponds with 2 flash chips; if all the unused bus interfaces of the SBC are utilized and converted into more bus interfaces of flash storage cards or flash chips correspondingly, then the writing bandwidth becomes even larger, and, thus, the battery capacity becomes even smaller.

For example, if two unused USB 2.0 bus of the SCB and one PCI bus (bandwidth 133M) are both connected to the ICC and transmit data in parallel, the bandwidth between the SBC and ICC is 60*2+133=253M Bps. Accordingly, although there are a number of flash storage cards or chips, little space is occupied and limited affect on system architecture is brought about, due to the small size of a single flash storage card or chip.

The above bus interface of the SBC may be a Peripheral Component Interconnection Bus Interface (PCI), a Peripheral Component Interconnection Express Bus Interface (PCI Express or PCI-E), a Serial Peripheral Component Interconnection Express Bus Interface (Serial PCI-E), a Peripheral Component Interconnection Bus Extension Interface (PCI-X), a Serial ATA Interface (SATA), a Serial Attached Small Computer Systems Interface (SAS), an IDE Interface, or a USB, etc. The bus interface of non-volatile flash storage medium is the IDE Interface, local bus interface, or Serial Peripheral Interface (SPI).

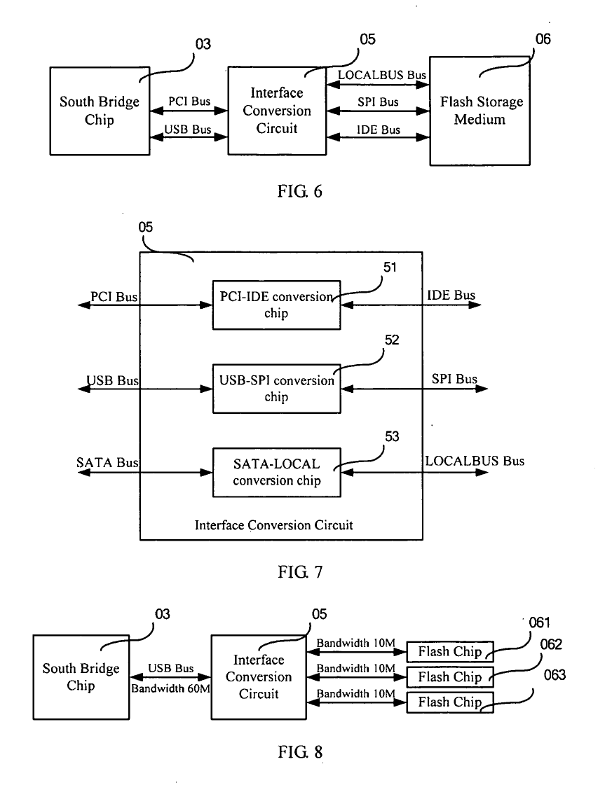

FIG. 6 shows a schematic diagram of one embodiment of the apparatus for power-fail protection according to the invention.

As shown in FIG. 6, the apparatus includes: a SBC 03, configured to control various interfaces of the storage system; a flash storage medium 06, configured to store data; and an ICC 05 connected to the SBC 03 and the flash storage medium 06, configured to convert the bus interface(s) of the SBC 03 into the bus interface(s) of the flash storage medium 06 and in case of failure of system power supply, to transmit the unsaved data in the memory to the corresponding non-volatile flash storage medium via the bus interface(s) connected to the SBC.

The embodiment can be understood with the help of the flow charts and descriptions of the method of the embodiment. The ICC is installed between the SBC 03 and the flash storage medium 06, and writes the unsaved data in the memory into flash storage medium 06 via the SBC 03. The embodiment has the same benefits and functions as the method of the embodiment, such as low power consumption, easy upgrading, little affect on architecture, saving system space, permanent data retention, no extra cost, and maximally lowered power consumption.

FIG. 7 shows a schematic diagram of an embodiment of the ICC in the apparatus for power-fail protection according to the invention. Those skilled in the art should understand that other than PCI Express, buses from the SBC usually further include the PCI, PCI-X, SATA, SAS, IDE, USB, etc. While the embodiment describes the internal structure of the ICC by taking the PCI, SATA, and USB of the SBC as examples, those skilled in the art should understand that the embodiment is merely one example of the ICC 05, and that different internal conversion chips may be used based on specific interfaces of the SBC and flash storage medium.

As shown in FIG. 7, the ICC 05 of the embodiment includes: a PCI-IDE conversion chip 51 connected to the PCI bus interface of the SBC and the IDE bus interface of one flash storage card, configured to convert a PCI bus interface into an IDE bus interface, so as to implement the conversion function of the bus interface by using, for example, a special interface conversion chip or a programmable logic device; a USB-SPI conversion chip 52 connected to the USB bus interface of the SBC and the SPI bus interface of one flash storage card, configured to convert a USB bus interface into a SPI bus interface, so as to implement the conversion function of bus interface from the USB bus interface to the SPI bus interface by using, for example, a programmable logic device; and a SATA-local bus conversion chip 53 connected to the SATA bus interface of the SBC and the local bus interface of one flash storage card, configured to convert a SATA bus interface into a local bus interface, so as to implement the conversion function of bus interface from the SATA to the local bus by using, for example, a programmable logic device.

As is shown in the ICC 05 of the embodiments in FIG. 6 and FIG. 7, the ICC mainly implements conversion of bus interfaces from the SBC and bus interfaces of the flash storage medium. The bus interface of the SBC usually includes the PCI, PCI-X, SATA, SAS, IDE, USB, etc; and the bus interface of flash storage medium includes the IDE, local bus, SPI, etc. Because the bus interface of the SBC is different from the bus interface of the flash storage medium, communication and data exchange between the two interfaces can only be completed by using the ICC, to implement conversion between the SBC and flash storage medium. The conversion chips in the ICC may be implemented by special interface conversion chips or programmable logic devices.

FIG. 8 shows a schematic diagram of one embodiment of the SBC and the ICC in the apparatus for power-fail protection of the invention. Usually the transmission bandwidth of south bridge bus is much higher than the bandwidth of flash storage medium, and therefore the bandwidth for writing data may be raised by just increasing the bandwidth of flash storage medium. According to the embodiment, in the ICC design, one bus interface of the SBC is converted into a data interface that corresponds to a plurality of storage mediums, into which the data is written in parallel, thus obtaining multiplied bandwidth. As shown in FIG. 8, the USB 2.0 interface is provided between the SBC and the ICC, and has a bandwidth of 60 Mega Byte per second (M Bps); the bandwidth of one flash chip is 10M Bps; the ICC converts a USB 2.0 interface for corresponding simultaneously to three identical flash chip bus interfaces, and writes data in parallel, so that the bandwidth of writing into flash chip is increased to be 3*10M Bps=30M Bps.

Generally, battery capacity=the minimum power consumption that enables writing the memory data into flash storage medium*(total memory capacity/writing bandwidth).

As can be seen from the battery capacity equation, under the condition of constant minimum power consumption and total the memory capacity, the higher the bandwidth of writing into flash storage medium, the smaller battery capacity is required. Detailed description may be referred to the corresponding method embodiments, and will not be elaborated any further. According to the embodiment, one third of the battery capacity is required as writing bandwidth triples, therefore, satisfying the requirement of slow development of battery.

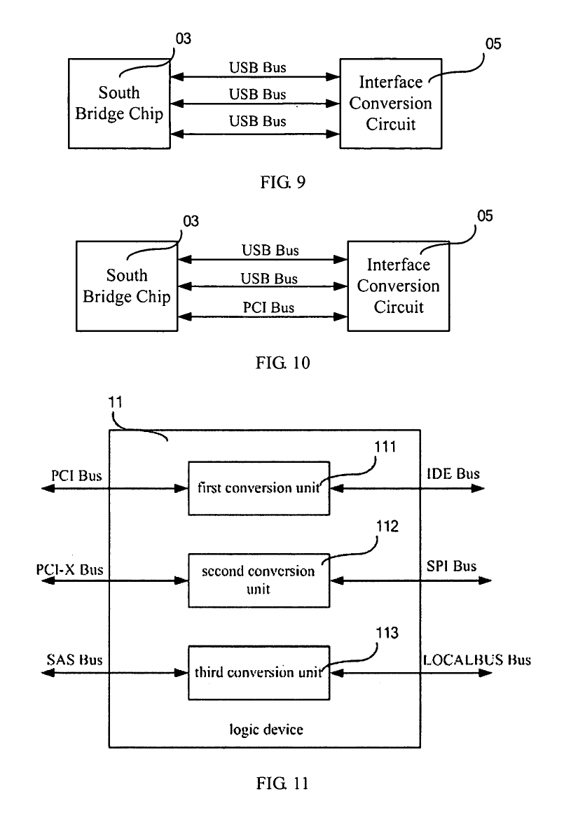

FIG. 9 shows a schematic diagram of another embodiment of the SBC and the ICC in the apparatus for power-fail protection of the invention. In the embodiment of FIG. 8, one bus of the SBC is converted into corresponding interfaces of a plurality of flash chips; while in the present embodiment, more than one bus interfaces of the SBC are connected to ICC simultaneously to further increase bandwidth between the SBC and the ICC. As is shown in FIG. 9, USB 2.0 buses of 60 MBps are connected simultaneously to the ICC, and data is transmitted in parallel, so that the bandwidth between the SBC and the ICC is 60*3=180 MBps.

FIG. 10 shows an exemplarily schematic diagram of yet another embodiment of the SBC and the ICC in the apparatus for power-fail protection of the invention. Different bus interfaces of the SBC are connected to the ICC simultaneously to increase bandwidth between the SBC and the ICC. As shown in FIG. 10, two USB 2.0 buses of 60 MBps and one PCI bus of 133 MBps are connected simultaneously to the ICC, data is transmitted in parallel, so that the bandwidth between the SBC and ICC is 60*2+133=253 MBps.

Compared with the solution of using hard disks as safe box for power-fail protection in the prior art, the above embodiments use flash storage medium as safe box for power-fail protection, which brings lower power consumption, higher bandwidth, and, therefore, much lower requirement on battery capacity. Table 1 is a comparison table between the embodiments of the invention and prior art under a certain kind of typical configuration:

TABLE 1
Example of Comparison of Requirement on Battery Capacity in the
invention with prior art

| | Minimum power | | | |
|---|---|---|---|---|
| | consumption that | | | |
| | enables writing | Total | | |
| | memory data into | memory | Writing | Battery |
| | storage medium | capacity | bandwidth | capacity |
| Prior art | 400 W | 8 GByte | 60 MBps | 14.8 wh |
| | | | | (watt hour) |
| Solutions used in | 350 W | 8 GByte | 120 MBps | 6.5 wh |
| embodiments of | | | | (watt hour) |
| the invention | | | | |

As can be seen from Table 1, under the condition of equal total the memory capacity, the solutions of the present invention lower the requirement on battery capacity by more than half.

In summary, compared with the prior art, in the embodiments of the invention, the power consumption in case of using the CF card, MMC card, SD card, XD card, flash chip, etc. as storage medium is much lower than using a hard disk as storage medium, and the requirement on battery capacity is lowered. Meanwhile, power consumption can be minimized by determining the capacity and the number of flash storage cards or flash chips based on the size of the memory that the system needs to protect, and stopping power supply to other peripheral chips during power-fail protection.

In ICCs, the bandwidth between ICCs may be effectively raised by connecting the free buses of the SBC to ICCs and writing data in parallel. With regard to various storage mediums, including hard disks and flash chips, usually it is their own bandwidths that limit their writing bandwidths. According to the above embodiments of the present invention, in the design of bus interface conversion circuit, a bus interface of the SBC is converted into a data interface that corresponds with a number of storage mediums, into which the data is written in parallel, thus, realizing multiplied bandwidth. Additionally, even higher data bandwidth may be realized by making full use of all the free buses of the SBC and connecting them to the ICC for interface conversion. The ICC may correspond to a plurality of flash storage mediums simultaneously and write data in parallel.

The development of capacity of the flash storage medium is very fast, and can mostly satisfy the rapid development of requirement on the memory capacity. Even when this requirement reaches 128 GBytes, 256 GBytes, 512 GBytes, or even larger, the requirement can be met without modifying system architecture by simply choosing flash storage medium of larger capacity, or meanwhile raising as well the capacity of safe box by increasing the number of storage mediums. The small sizes of flash storage mediums make the effect of adding them on system architecture very limited.

FIG. 11 shows a schematic diagram of an embodiment of the logic device of the present invention.

As is shown in FIG. 11, the logic device 11 of the embodiment includes: a first conversion unit 111 connected to the PCI bus interface of the SBC and the IDE bus interface of one or more flash storage cards, configured to convert a PCI bus interface into an IDE bus interface; a second conversion unit 112 connected to the PCI-X bus interface of the SBC and the SPI bus interfaces of a number of flash storage cards, configured to convert a PCI-X bus interface into a SPI bus interface; and a third conversion unit 113 connected to the SAS bus interface of the SBC and local bus interfaces of a number of flash storage cards, configured to convert a SAS bus interface into a local bus interface.

Those skilled in the art should understand that buses from the SBC include the PCI Express, PCI, PCI-X, SATA, SAS, IDE, USB, etc., and bus interfaces of non-volatile flash storage medium include IDE interface, local bus interface or SPI interface, etc. The embodiment describes the inner structure of the logic device by taking the PCI, PCI-X, and SAS of the SBC as examples. Those skilled in the art should understand that the embodiment is only an example of a logic device 11, and that a number of inner conversion units may be configured, based on specific interfaces of the SBC and the flash storage medium.

Referring to the ICC 05 of embodiments of FIGS. 7-10, the logic device 11 of the embodiment realizes the same converting functions as the ICC of embodiments of FIGS. 7-10, e.g. a fourth conversion unit may be added in the embodiment of FIG. 11, to realize conversion from the USB of the SBC into the IDE interface of the non-volatile storage medium. In the embodiment of FIG. 11, one end of each conversion unit is connected to one bus interface of the SBC; the other end is connected to a number of flash storage cards or storage chips in parallel, so as to realize increased writing bandwidth of the conversion. The details can be referred to embodiments of FIGS. 8-10 and the relevant descriptions.

The present embodiment may implement respective functions with programmable logic devices, such as Field-Programmable Gate Array (FPGA), and Complex Programmable Logic Device (CPLD).

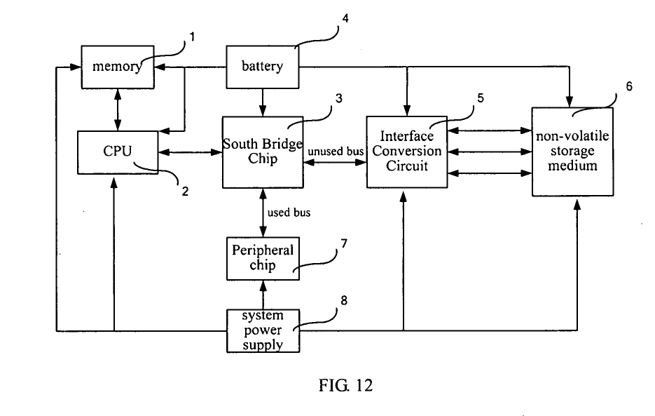

FIG. 12 shows a schematic diagram of an embodiment of the storage system of the present invention. As shown in FIG. 12, the storage system of the embodiment includes: a system power supply 8, configured to supply the storage system with power under normal conditions of the system; a SBC 3, configured to control various interfaces of the storage system; a non-volatile flash storage medium 6, configured to save data; an ICC 5 connected to the SBC 3 and the non-volatile flash storage medium 6, configured to convert the bus interface(s) of the SBC 3 into the bus interface(s) of the non-volatile flash storage medium 6; a system memory 1 connected to central processing unit (CPU) 2, configured to directly communicate with the CPU 2 and storage of the currently used data and programs; a battery 4 connected to the SBC 3, the non-volatile flash storage medium 6, ICC 5, the system memory 1, and the CPU 2, configured to supply power for these parts in case of system power failure; and the CPU 2 connected to the SBC 3 and the system memory 1, configured to transmit the unsaved data in the memory to the corresponding non-volatile flash storage medium via the ICC by using the unused bus interface(s) of the SBC.

The embodiment is a storage system, including a peripheral chip 7 that is connected to an occupied bus of the SBC, for storage in case of power failure. The details are also illustrated in the descriptions of embodiments of FIGS. 6-10, and are not further elaborated.

The present invention may be implemented by a number of different types of embodiments. The above embodiments shown in FIGS. 3-12 are examples that illustrate the technical solutions of the present invention, and are not intended to limit the scope of embodiments of the present invention within any specific flows or structures. Those skilled in the art should understand that the embodiments as stated above are only some examples of many preferred implementations, and that any embodiment that implements power-fail protection using unused bus(es) of the SBC and flash storage medium should be included in the scope of the disclosure.

Those skilled in the art should understand that all or some steps of the methods of the above embodiments may be performed by a hardware executing relevant instructions of a program; the program may be stored in a computer readable storage medium and execute the steps included in the methods of the above embodiments; and the storage medium may include any medium that can store program codes, such as ROM, RAM, magnetic disk, or optical disk.

Finally, the above embodiments are only intended to illustrate the technical solutions of the present invention, and are not intended to limit the scope of the disclosure; despite the detailed description of the invention with reference to the above embodiments, those skilled in the art should understand that modifications on the technical solutions of the above embodiments and equivalent substitutions of some of their technical features are possible, and that these modifications or substitutions do not make the essence of their corresponding technical solutions deviate from the spirit and scope of the technical solutions of the embodiments of the disclosure.

What is claimed is:

1. A method for power-fail protection, comprising:
supplying, by a battery, power to a south bridge chip (SBC), a non-volatile flash storage medium, an interface conversion circuit (ICC) between the SBC and the non-volatile flash storage medium and a memory when a system power supply fails; and
transmitting unsaved data in the memory to the corresponding non-volatile flash storage medium via the ICC, by use of an unused bus interface of the SBC;
wherein the ICC is configured to convert a bus interface of the SBC into a corresponding bus interface of the non-volatile flash storage medium.

2. The method of claim 1, further comprising:
supplying power by the system power supply, reading the data stored in the non-volatile flash storage medium and writing the read data into the memory via the ICC and the SBC, when the system power supply is recovered to work normally.

3. The method of claim 1, wherein the ICC is configured to convert a bus interface of the SBC into a bus data interface corresponding to a plurality of non-volatile flash storage mediums.

4. The method of any of claims 1, wherein the step of the transmitting comprises:
transmitting the unsaved data in the memory to the corresponding plurality of non-volatile flash storage mediums via the ICC, by use of one unused bus interface of the SBC; or
transmitting the unsaved data in the memory to the corresponding plurality of non-volatile flash storage mediums via the ICC, by use of a plurality of unused bus interfaces of the SBC.

5. An apparatus for power-fail protection, comprising:
a south bridge chip (SBC), configured to control interfaces of a storage system;
a non-volatile flash storage medium, configured to storing data; and
an Interface conversion circuit (ICC) connected to the SBC and the non-volatile flash storage medium, configured to convert a bus interface of the SBC into a corresponding bus interface of the non-volatile flash storage medium; and when a system power supply fails transmit data not stored in a memory to the corresponding non-volatile flash storage medium via a bus interface connected to the SBC.

6. The apparatus of claim 5, wherein the ICC comprises a plurality of conversion chips configured to convert Peripheral Component Interconnection Bus Interface, Peripheral Component Interconnection Express Bus Interface, Serial Peripheral Component Interconnection Express Bus Interface, Peripheral Component Interconnection Extension Bus, Serial ATA Bus, Serial Attached Small Computer Systems Bus, Integrated Drive Electronics Bus, or Universal Serial Bus into one or more Integrated Drive Electronics Buses, local buses, or Serial Peripheral Buses.

7. The apparatus of claim 5, wherein the non-volatile flash storage medium comprises Compact Flash Card, Multimediums Card, Secure Digital Card, Extreme Digital Card, flash chip, or any combinations thereof.

8. The apparatus of claim 5, wherein the bus interface of the SBC comprises Peripheral Component Interconnection Bus Interface, Peripheral Component Interconnection Express Bus Interface, Serial Peripheral Component Interconnection Express Bus Interface, Peripheral Component Interconnection Bus Extension Interface, Serial ATA Interface, Serial Attached Small Computer Systems Interface, Integrated Drive Electronics Interface, Universal Serial Bus, or any combination thereof.

9. The apparatus of claim 5, wherein the bus interface of the non-volatile flash storage medium is Integrated Drive Electronics Interface, local bus interface, or Serial Peripheral Interface.

10. A logic device, comprising at least one conversion unit, configured to convert a bus interface of a South Bridge Chip (SBC) into a corresponding bus interface of at least one non-volatile storage mediums;
wherein one end of each conversion unit is connected to the bus interface of the SBC, and other end of each conversion unit is connected to the corresponding bus interface of the non-volatile storage mediums.

11. The logic device of claim 10, wherein the bus interface of the non-volatile storage mediums is Integrated Drive Electronics Interface, local bus interface, or Serial Peripheral Interface.

12. The logic device of claim 10, wherein the bus interface connecting the conversion units and the SBC is Peripheral Component Interconnection Bus Interface, Peripheral Component Interconnection Express Bus Interface, Serial Peripheral Component Interconnection Express Bus Interface, Peripheral Component Interconnection Bus Extension Interface, Serial ATA Interface, Serial Attached Small Computer Systems Interface, Integrated Drive Electronics Interface, Universal Serial Bus, or any combination thereof.

13. A storage system, comprising:
a system power supply, configured to supply the storage system with power under normal conditions of the system;
a South Bridge Chip (SBC), configured to control interfaces of the storage system;
a non-volatile flash storage medium, configured to storing data;
an Interface Conversion Circuit connected to the SBC and the non-volatile flash storage medium, configured to convert a bus interface of the SBC into a bus interface of the non-volatile flash storage medium;
a system memory connected to a central processing unit (CPU), configured to directly communicate with the CPU and store data and program which are used currently;
a battery connected to the SBC, the non-volatile flash storage medium, the ICC, the system memory and the CPU, configured to supply power to these connected components in case of system power failure; and
the CPU connected to the SBC and the system memory, configured to transmit data not stored in the system memory to the corresponding non-volatile flash storage medium via the ICC, by use of an unused bus interface of the SBC, in case of system power failure.
